(19) United States
(12) Patent Application Publication
(10) Pub. No.: US 2025/0242466 A1
(43) Pub. Date: Jul. 31, 2025

(54) ABRASIVE ARTICLE ATTACHMENT SYSTEMS AND METHODS

(71) Applicant: 3M INNOVATIVE PROPERTIES COMPANY, St. Paul, MN (US)

(72) Inventors: Joseph B. Eckel, Vadnais Heights, MN (US); Aaron K. Nienaber, Lake Elmo, MN (US); Nathan J. Herbst, Woodbury, MN (US)

(21) Appl. No.: 18/848,411

(22) PCT Filed: Mar. 13, 2023
(86) PCT No.: PCT/IB2023/052404

§ 371 Date: Sep. 18, 2024

Related U.S. Application Data
(60) Provisional application No. 63/269,725, filed on Mar. 22, 2022.

(51) Int. Cl. B24B 41/00; B25J 11/00

(52) U.S. Cl. CPC B24B 41/005; B24B 41/002; B25J 11/0065

(57) ABSTRACT

A robotic system for modifying a surface is presented. The system includes a motive robot arm with an arm movement mechanism. The system also includes a tool coupled to the arm movement mechanism. The tool is configured to removably couple to an article configured to contact the surface. The system also includes a first actuator that causes the arm movement mechanism to move the tool into a pickup position with respect to the article. The system also includes a second actuator that causes a shearing motion, during an article attachment step, between the article and the tool. The coupling between the article and the tool comprises a hook and loop system.

### BACKGROUND

Surface repair and other grinding operations are an area of abrasive operations still being automated. Historically, human operated abrading devices provide more consistent control. Human operation is time consuming, inconsistent, and labor intensive. While robotic systems are known, techniques are desired for better control over automated grinding processes.

### SUMMARY

A robotic system for modifying a surface is presented. The system includes a motive robot arm with an arm movement mechanism. The system also includes a tool coupled to the arm movement mechanism. The tool is configured to removably couple to an article configured to contact the surface. The system also includes a first actuator that causes the arm movement mechanism to move the tool into a pickup position with respect to the article. The system also includes a second actuator that causes a shearing motion, during an article attachment step, between the article and the tool. The coupling between the article and the tool comprises a hook and loop system.

Systems and methods herein solve a key problem in the automation of industrial abrasive operations. A problem for robotic systems is reliably attaching and detaching items. Systems and methods herein improve the ability of a robotic abrading system to pick up an abrasive article without significantly inhibiting the ability of the abrasive article to be removed when replacement is needed.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 illustrates a robotic repair system in which embodiments herein may be useful.

FIG. 2 illustrate robotic grinding system components in accordance with embodiments herein.

FIGS. 3A-3B illustrate storage silos for articles that may be used in embodiments herein.

FIG. 4 illustrates a schematic of abrasive articles in a stack.

FIGS. 5A-5B illustrate abrasive articles incompletely coupled to a robotic tool.

FIGS. 6A-6B illustrates a schematic of an abrasive article being picked up from a silo in accordance with embodiments herein.

FIG. 7 illustrates a method of exchanging abrasive articles for a robotic tool in accordance with embodiments herein.

FIG. 8 illustrates a robotic abrading system in accordance with embodiments herein.

### DETAILED DESCRIPTION

Recent advancements in imaging technology and computational systems has made feasible the process of automating industrial abrasive operations at production speeds.

Robotic systems follow directions precisely, unlike human operators, who introduce variability into the process. The abrasive industry in particular often has human operators with years of experience that give them the ability to optimize and improve abrasive or polishing processes. In contrast, robotic systems need programming to mimic sophisticated human behavior, and are limited by sensor systems. For example, human operators can make adjustments in the attachment of an abrasive article to a tool, and can see whether or not the abrasive article falls off before contacting a substrate. A robot may not have that sensing capacity, or the disc may fall off after a sensing step.

The example of defect repair on a vehicle is described herein. However, it is expressly contemplated that systems and methods herein may apply broadly to any abrasive application where an abrasive article experiences wear, loading, degradation, or otherwise needs to be exchanged.

The term “abrasive article” is used herein and is intended to cover broadly articles that may be picked up by a robotic tool for contacting a substrate during an abrasive operation. Abrasive articles may include traditional abrasive discs or belts, nonwoven pads with abrasive particles, or grinding wheels. However, abrasive articles may also include articles used in an abrasive operation, such as wipes, polishing pads, etc., as these articles often utilize the same attachment systems of traditional abrasive articles and suffer from the same problems with reliable initial attachment.

The term “shearing movement” is used herein to broadly describe movement of a tool (or a backup pad attached to a tool) with respect to an abrasive article. Shearing movement refers to relative movement between a backup pad and an article being coupled to the backup pad. Relative movement, as used herein, refers to one of the tool and the article moving while the other remains substantially stationary, or moves in a different direction. The movement may include linear, rotational, random orbital, arc, a combination thereof or another suitable movement. Movement may include the tool moving, a portion of a robot coupled to the tool moving, the abrasive article moving, a storage component housing the abrasive article moving, or movement of an object to which the robot or storage component are mounted, such as a table. Movement may be actuated by any suitable mechanical movement mechanism such as a robot arm, end effector, or spindle, a servo motor associated with an article storage housing, e.g. mounted to the housing directly or indirectly.

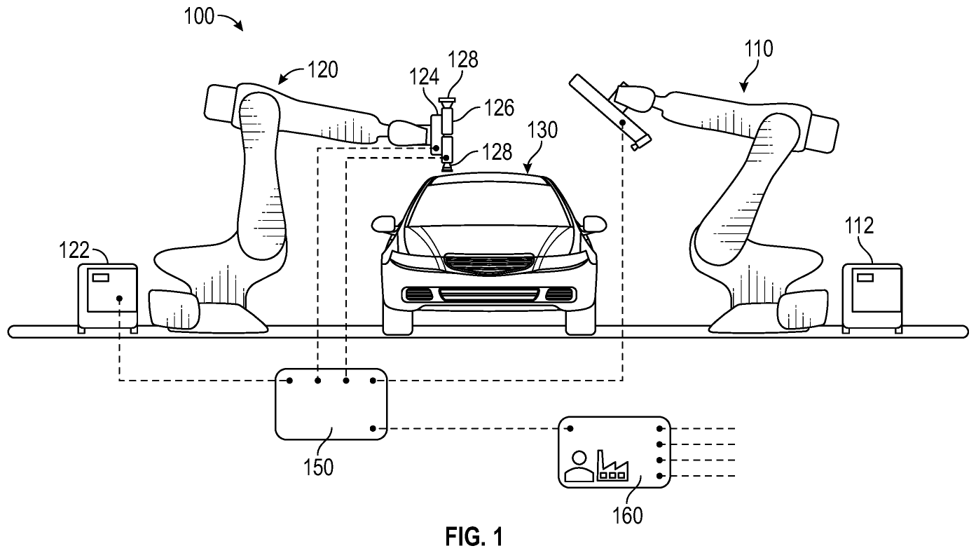

FIG. 1 is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two tools 128. However, other arrangements are also expressly contemplated. While a visual inspection system 110 is illustrated in FIG. 1, it is expressly contemplated that systems and methods herein may not require a vision system.

The current state of the art in vehicle paint repair is to use fine abrasive and/or polish systems to manually sand/polish out the defects, with or without the aid of a power tool, while maintaining the desirable finish. An expert human executing such a repair leverages many hours of training while simultaneously utilizing their senses to monitor the progress of the repair and make changes accordingly. Such sophisticated behavior is hard to capture in a robotic solution with limited sensing.

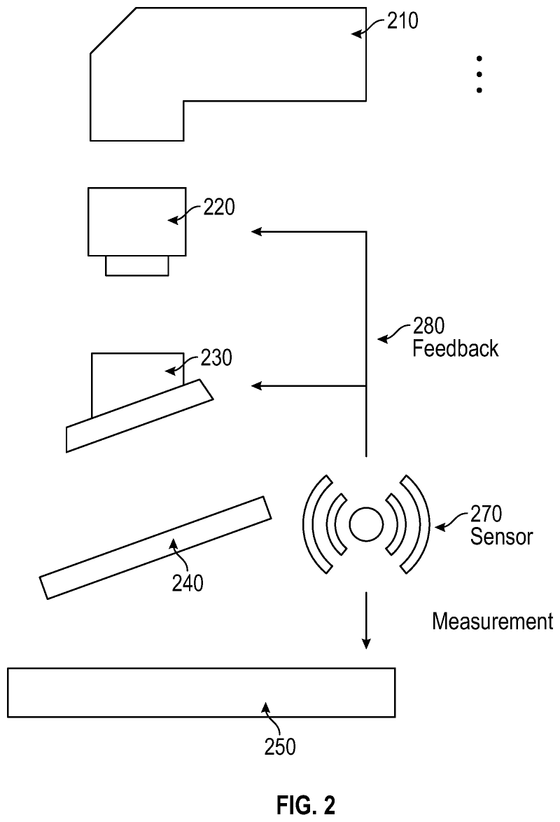

FIG. 2 illustrates robotic abrading system components in accordance with embodiments herein. A robotic abrading unit may be stationary, in some embodiments, or may be mobile, in other embodiments. The robotic abrading unit may have one or more joints with one or more degrees of freedom. For example, a single robot arm component 210 is illustrated in FIG. 2, but it is expressly contemplated that arm 210 may actually be composed of several subcomponents, each coupled by a joint that allows one or more degrees of freedom. Further, while discussion is limited herein to movement ranges and abilities of arm component 210, it is expressly contemplated that a robotic unit may have multiple moveable arm components extending from a base (not shown in FIG. 2) to a force control unit. The base may also have multiple degrees of freedom in which to move, as may each of its articulated components. The base may also have a movement mechanism, such as motorized wheels that allow robotic arm 210 to move closer to, or further away from, workpiece 250.

An end effector 220 may be coupled to robotic arm 210, either directly or through a force control unit, for example. End effector 220 may control movement of an abrasive article 240 in a rotational or random orbital pattern. End effector 220 can exert a pressing force through a backup pad 230, forcing abrasive 240 into contact with workpiece 250. A relative position of backup pad 230 to workpiece 250 may be adjusted, as illustrated in FIG. 2. Additionally, backup pad 230 may rotate with respect to workpiece 250, for example by rotating a tool spindle, or using end effector 220. Abrasive 240 can be selected from any suitable abrasive article including bonded abrasive articles, nonwoven abrasive articles, or coated abrasive articles. Examples described herein illustrate coated abrasive discs and polishing pads. However, it is expressly contemplated that other abrasive articles may also be used with systems and methods herein.

A robotic system may include one or more sensors 270. Among other parameters, a sensor 270 may be capable of detecting information related to a real-time status of robotic arm 210, abrasive article 240 or substrate 250. Sensor 270 may, for example, be an optical sensor that checks to ensure that abrasive article 240 is in contact with backup pad 230 after a pick-up operation. However, as described herein, in many robotic systems sensor 270 checks for the presence of abrasive article 240 after a pick-up operation, but not again before robotic arm 210 moves into a position to place abrasive article 240 in contact with substrate 250. If the abrasive article falls off backup pad 230 during transit from a pickup location to substrate 250, there may be no way to detect it, and backup pad 230 may directly contact, and potentially damage substrate 250 and will not sand out the defect. While a human operator could see or feel or hear that an abrasive article was no longer present when contacting substrate 250, the robotic system of FIG. 2 is dependent on sensor information.

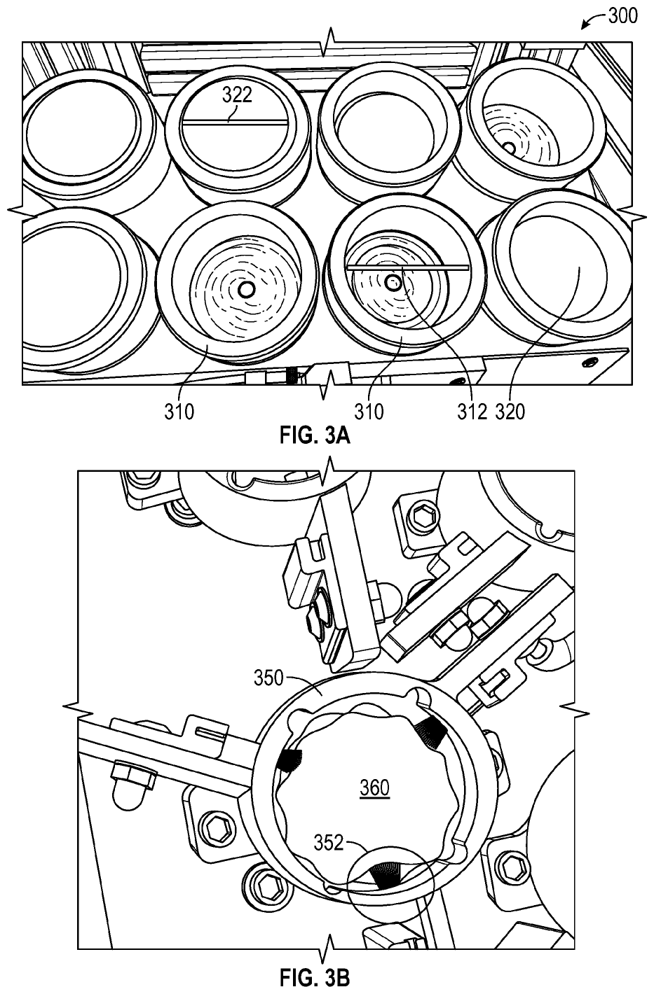

FIGS. 3A-3B illustrate abrasive article silos which may be used in embodiments herein. A robotic abrading system may use a number of consumable abrasive products during a work shift. FIG. 3A illustrates storage silos 310 in an arrangement 300, each containing a number of abrasive articles 320. Abrasive articles 320 illustrated in FIG. 3A are polishing pads. A number of abrasive article storage silos 310 may be located together, as illustrated in arrangement 300, because of how frequently they may need to be exchanged. FIG. 3B illustrates abrasive articles 360 in a different silo configuration 350. Abrasive articles 360 illustrated in FIG. 3B are coated abrasive discs. As illustrated in FIG. 3B, silo 350 may have a number of features 352. It is desired that, during a pickup operation, only a single abrasive article is retrieved at a time, so features 352 may provide sufficient resistance (similar to the plastic film in a KLEENEX® tissue box) such that only one abrasive article is released at a time. FIG. 3B illustrates a number of brushes 352. However other resistance mechanisms may be used, such as flaps or tabs that separate adjacent abrasive articles. It is also envisioned that, in some embodiments, silo 310 is a non-rigid, compressible or flexible material such that rotation of the substrate does not cause the tool to bump into a hard outer wall. In embodiments where a large counterbalance orbit is used on the tool, movement may be orbital or random orbital.

Referring again to FIG. 3A, storage silo 310 has a diameter 312, which is sized to fit abrasive article 320 with an article diameter 322. Silo diameter 312 may be sized such that it is substantially the same as diameter 322, in order to provide resistance and ensure precise spatial location to allow for precise, repeatable placement of the abrasive article on a substrate. However, it is expressly contemplated that, in some embodiments, diameter 312 is larger than diameter 322, for example up to 20% larger. Additionally, in embodiments where the silo is a compressible or flexible, diameter 312 may be up to 10% smaller than diameter 322.

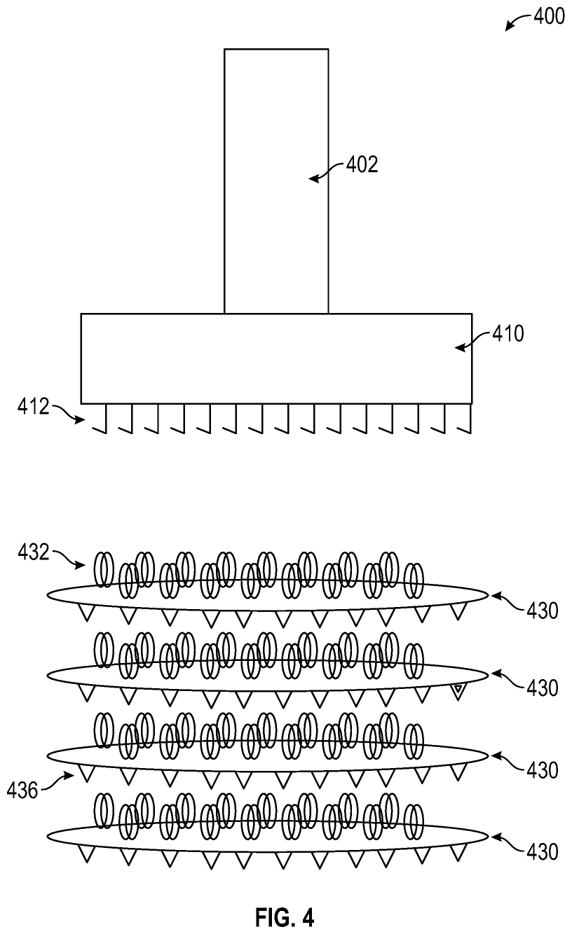

FIG. 4 illustrates a schematic of abrasive articles in a stack. Abrasive articles 430 are stacked in a storage silo (not shown in FIG. 4). As illustrated in schematic 400, a spindle 402 is coupled to a backup pad (or other suitable tool) 410, which then couples to an abrasive article 430 using a hook and loop system. While FIG. 4 illustrates a schematic where backup pad 410 has a plurality of hooks 412 that engage loops 432 of an abrasive article 430, it is expressly contemplated that, in other embodiments, tool 410 has a plurality of loops and abrasive articles 430 have a plurality of loops.

As illustrated in schematic 400, each abrasive article 430 has two sides—an abrasive side, with a plurality of abrasive particles 436 configured to contact a substrate, and an attachment side with a number of attachment features 432 (e.g. loops, as illustrated in FIG. 4).

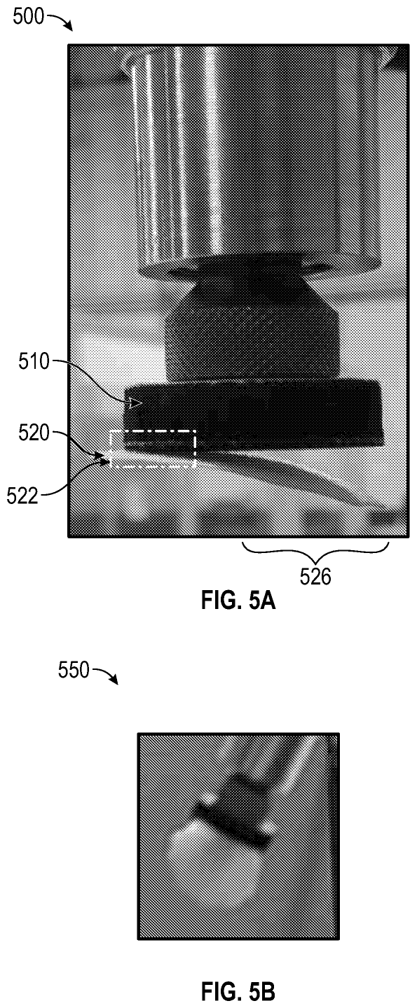

When a human attaches an abrasive article to a tool using a hook and loop attachment system, the movement is not purely linear and the human operator is able to see and feel whether or not an abrasive article 430 is sufficiently connected to tool 410. A robot, however, is not able to “see” or “feel” the abrasive article 430 without sensors configured to provide such information. Referring to FIGS. 5A and 5B, simply urging tool 410 against the stack of abrasive articles 430 by simply pressing down orthogonally is not always sufficient to ensure coupling of the hook and loop system.

One potential solution to the coupling problem is to use a more aggressive attachment system, e.g. adding an adhesive, interlocking features, more dense, or taller hook and loop, etc. However, it is also necessary to be able to easily remove a used abrasive article when it has experienced significant wear, loading or degradation. It is known that as abrasive articles experience friction, heat and pressure from the abrasive operation, the attachment strength of the article to the back up pad can increase substantially. The coupling mechanism, therefore, needs to be aggressive enough to ensure sufficient attachment of abrasive article 430 to tool 410, while also being removable.

Abrasive articles 430 are stacked such that the abrasive side of a first article 430, with particles 436, contact the attachment side, with loops 432, of an adjacent abrasive article. There can be some coupling that happens between particles 436, which often form a rough surface, and loops 432, which are designed to interact with, and couple to, the rough surface of hooks 412. Accidental coupling may also occur between disc edges and loops of adjacent articles. This causes resistance and a potential for tool 410 to grab multiple abrasive articles 430 in a single pick up operation. For this reason, an abrasive article silo may have features (e.g. features 352, in one embodiment) that help to separate adjacent abrasive articles from one another during a pickup operation. However, both the resistance created by contact between abrasive articles 430, and any resistance features, increases a strength of coupling between hooks 412 and loops 432 needed to sufficiently attach abrasive article 430 to the back-up pad. In other instances, the silo walls tightly fit to the articles in storage to provide more precise positioning. This friction may provide similar, or alternative resistance to the brushes illustrated.

While embodiments herein illustrate an abrasive article housing, such as a silo, it is expressly contemplated that this may not be present for all abrasive articles. For example, while abrasive discs may need to be changed as often as 50 times or more during a shift, a stack of them is needed that keeps the abrasive articles available in a known position. However, for other articles that are not as frequently changed out, such as buff pads, the article may be retained in a known position in another suitable form. For example, buff pads may be placed in designated positions by a human operator, and held in place by pins, clamps, vacuum or another suitable mechanism on a surface with high enough friction to provide resistance to the abrasive article moving with the tool. For example, a rubber surface may help retain the abrasive article in a stationary position, or reduce slippage, such that a shearing motion can occur as described herein.

FIGS. 5A-5B illustrate abrasive articles incompletely coupled to a robotic tool. In some cases, the disc never attaches at all or falls off as soon as the robot makes any movements. Because of the resistance described with respect to FIG. 4, it is often the case that an abrasive article does not completely couple to an abrading tool or, in some instances, not be removed from the dispensing silo at all. As illustrated in FIG. 5, a coupling 500 between a tool 510 and an abrasive article 520 is incomplete, with abrasive article 520 only coupled to tool 510 by a portion 522 of the hook and loop surface, with a majority 526 of the surface area unattached. Similarly, as illustrated in image 550, an abrasive article is barely attached to a tool. Rapid robot motion while the article is insufficiently attached can further increase the chances of the article falling off. In some embodiments, a sensor can detect that an abrasive article has coupled to a tool—which is the case in both FIGS. 5A and 5B—after a pickup operation. And, once in contact with a substrate, the coupling between abrasive article 520 and tool 510 improves with increased friction, shearing forces and heat applied. But, if abrasive article 520 disengages from tool 510 between the sensor and the substrate, then the tool 510 will be directly contacting, and grinding, a substrate surface. This can cause damage to both tool 510 and the substrate and will not sand the substrate as expected.

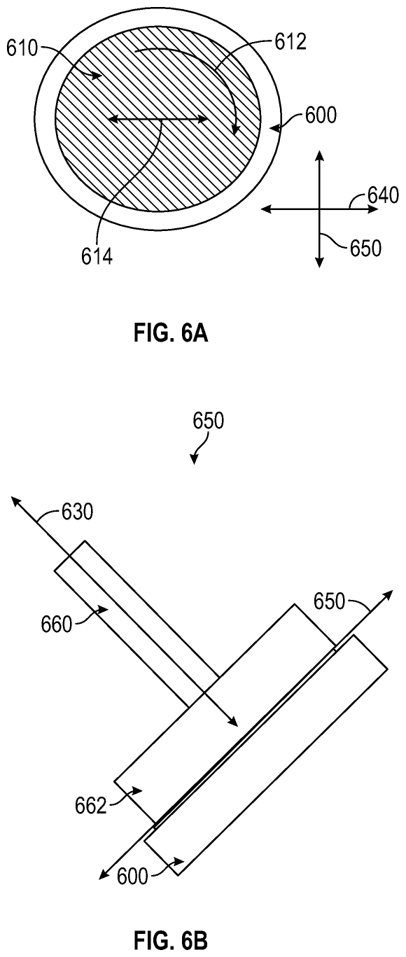

FIG. 6 illustrates a schematic of an abrasive article being picked up from a silo in accordance with embodiments herein. As discussed above, it is imperative that abrasive articles be easily removeable from a tool after their service life is completed. So any coupling between a tool and an abrasive article has to be stable enough to get the abrasive article to a substrate for abrading, but not so robust as to be irremovable after heat and shearing forces are applied to the abrasive article. Additionally, it is important for a robot to be able to return to a specified location to pick up the next abrasive article, when needed. Because some tools can cause damage to a substrate if in contact, it is not only necessary for said tool to sufficiently couple to an abrasive article, it has to do so with the right relative position such that the abrasive article covers the entire surface area of the tool and be correctly centered on the tool so as to not cause imbalance during high speed rotation. For that reason, the abrasive articles may be stacked as illustrated in FIGS. 3A-3B, with resistance mechanisms in place to ensure a single abrasive article is withdrawn from the silo at a time and to keep articles centered in a precise location. However, staking creates the issue of entanglement between adjacent abrasive discs as discussed with respect to FIG. 4.

Because a stronger attachment system may make it difficult to speedily remove the abrasive article when its use is finished, a mechanical shearing force is applied instead. This causes more coupling between the hook and loop attachment system of the backup pad and the abrasive article while the abrasive article is still in position in the silo. The applied shearing force operates similarly to the shearing stress the coupling experiences when in contact with the substrate, but is applied during the pickup operation to improve the initial coupling. Importantly, the shearing stress needs to be applied during the pick-up operation without increasing removal difficulty.

FIGS. 6A-6B illustrates a schematic of how a shearing force can be imparted to abrasive article 610, by a tool (not shown) while abrasive article is still in silo 600. After the tool contacts abrasive article, the tool is moved with respect to the abrasive article, inducing shearing and causing more hooks to couple to loops and, therefore, improve the initial attachment between the tool and abrasive article 610. Importantly, the shearing stress induced would be experienced by a tool and abrasive article 610 during an abrasive operation (either by a robotic arm moving abrasive article across a surface of a substrate, spinning abrasive article while in contact with the substrate, or both), so while an initial attachment is improved during pickup, removal difficulty is not substantially affected.

FIG. 6A can be understood as a top-down view of a tool contacting an abrasive article. FIG. 6B illustrates a side or cutaway view of a tool 660, coupled to a backup pad 662, contacting an abrasive article. Backup pad 662 couples to an abrasive article housed in storage silo 670. Tool moves along axis 630, which is herein referred to as the Z-axis. Shearing may occur in the X-Y plane. Y-axis 650 is illustrated in both FIGS. 6A and 6B. X-axis 640 is illustrated in FIG. 6A, and go into and out of the page of FIG. 6B. In FIG. 6A, the Z-axis goes into and out of the page.

Shearing forces can be induced in two ways, as shown in FIGS. 6A-B—either by linear movement 614 between a tool and an abrasive article 610, or rotational movement 612.

It is also contemplated that, if movement is caused by an end effector, it may be random orbital movement and therefore impart an “arc” shape. In short, any movement in the X-Y plane will increase coupling. Vibration of a tool against abrasive article 610 may be sufficient.

The actual movement mechanism causing the shearing forces may be caused by a spindle spinning a tool against the abrasive article 610, end effector (or robot arm) moving a tool against abrasive article 610, or silo 600 (or a movement mechanism associated with silo 600). Illustrated in FIG. 6, a tool may rotate 612 a quarter rotation against the abrasive article which remains stationary, which may be sufficient to improve coupling. However, more or less rotation may be needed depending on the type of abrasive article. FIG. 6 illustrates the motion 612 as going in one direction. However, it is expressly contemplated that, after rotating a specified angular distance (e.g. a quarter turn clockwise), a tool may rotate back the same specified angular distance (e.g. a quarter turn counterclockwise), to return to the starting position. This may be necessary for operations where a specific tool orientation is needed, or to help center the disc on the backup pad.

Inducing shearing forces can be done quickly, for example taking a fraction of the time of the total pick-up operation, such that a cycle time is not noticeably increased. Shearing forces improve coupling between a tool and an abrasive article without increasing removal difficulty or requiring a different coupling mechanism.

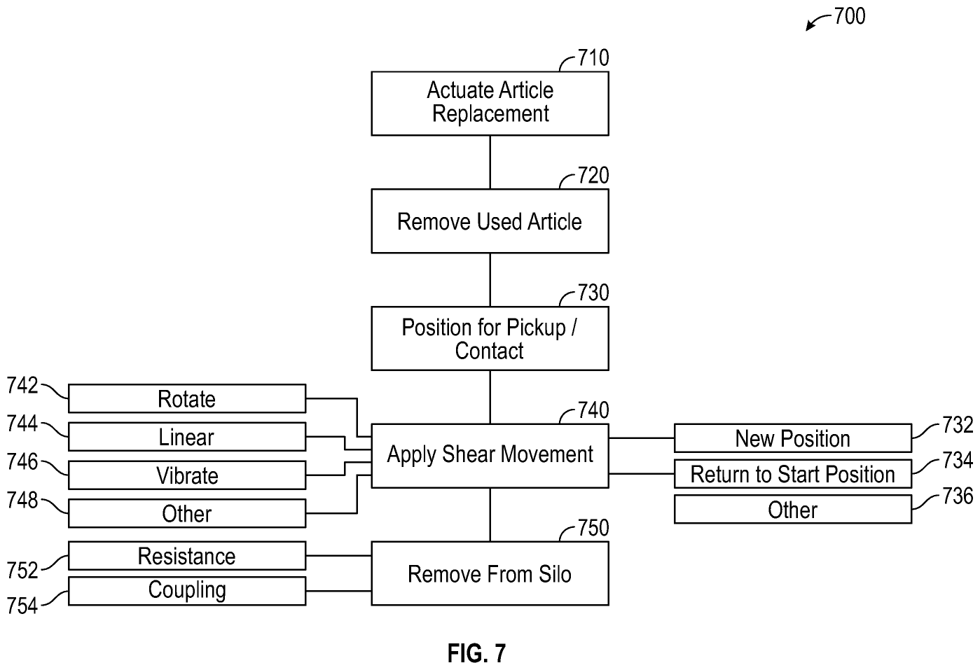

FIG. 7 illustrates a method of exchanging abrasive articles for a robotic tool in accordance with embodiments herein. Method 700 may be used for exchanging a used abrasive article for a new abrasive article. The abrasive article may be a sanding disc, polishing pad, or any suitable abrasive article for an abrading operation, such as a bonded abrasive article, a nonwoven abrasive article, an abrasive belt, wiping article or other consumable article for an abrasive operation.

In block 710, an article replacement operation is actuated. Actuation may be triggered by a controller sending an indication that an abrasive article has reached an end of its service life, for example based on a detected amount of wear, loading, degradation, or based on an operation count, or another suitable triggering event. For example, all abrasive articles may be replaced at the beginning or end of a shift.

In block 720, a used abrasive article is removed from a robotic abrading unit. As noted herein, it is important that abrasive articles be easily removeable after they have reached their service life. Therefore, an attachment between the abrasive article and a robotic tool cannot be too strong, or the abrasive article may not be removed, or completely removed. It is not desired for any significant portion of a used abrasive article be left behind as trajectories and applied forces are provided for the robot based on the assumption of a single abrasive article attached to a backup pad or otherwise coupled to a tool. The presence of an old abrasive article may inhibit the attachment of a new abrasive article, as the coupling mechanism of the backup pad is not available to couple to a new abrasive article, and changes the force profile applied to a new abrasive article on a substrate. In some embodiments, removing a used abrasive article involves passing the backup pad or tool in front of a sensor to confirm that the used abrasive tool has been removed.

In block 730, the robotic arm moves into a pickup position. In some cases, the abrasive article needs to be precisely placed on a backup pad, such that the backup pad is completely covered, or because the abrasive article will need to precisely contact a substrate for the abrasive operation. Therefore, as illustrated in FIGS. 3A-3B, in some embodiments a storage container of new abrasive articles may be sized to fit the abrasive articles so that the articles are all in substantially the same position for pickup.

Once the tool or backup pad contacts the abrasive article, a movement in the X-Y plane is made to increase the initial attachment strength. For a hook and loop attachment system, this increase in attachment strength is similar to what would have already happened when the abrasive article contacted a substrate for an abrading/polishing/wiping operation. Therefore, there is substantially no additional difficulty added, for step 720, to remove the abrasive article when its service life is over.

The movement can be any suitable movement in the X-Y plane of either the abrasive article or the backup pad. For example, the tool may rotate 742 while contacting the abrasive article, which remains stationary, in some embodiments. The rotation may be accomplished using an end effector or a tool spindle. Additionally, the term rotation is used broadly to refer to both rotary or random orbital movement. The shearing force may also be imparted by linear movement 744, e.g. the tool contacting the abrasive article and moving along either the X-axis or the Y-axis of an X-Y plane. However, any movement in the X-Y plane may be sufficient, for example a spiral, a parabolic movement, etc. Additionally, movement may be vibration 746 of either the backup pad or the abrasive tool. A shear movement may also be imparted in any other suitable manner 748.

In some embodiments, the precise orientation of the abrasive article is important for an abrasive operation. Therefore, the applied movement may be reversed, in some embodiments, such that the abrasive article returns to a starting position 734. In embodiments where the precise position is not important, the relative position of the tool may change to a new position 732, from an initial contact position. The new position may be laterally spaced from an original position, or may be a rotated, or moved along a random orbit, from the original position. However, another position 736 may also result from the shearing movement.

Additionally, it is expressly contemplated that the movement mechanism may be part of an abrasive article silo, e.g. such that the abrasive article, instead of the tool, moves. For example, a table or other article to which the silo is mounted may include the movement mechanism. The silo may be mounted to a movement mechanism directly, such as a slide, rail, spindle or other mechanism. The movement mechanism could be attached to a servo motor or other suitable component.

In block 750, the abrasive article is removed from a storage silo. The tool may pass in front of a sensor to confirm that a coupling 754 between the tool and the abrasive article is sufficiently present, in some embodiments. Additionally, as described herein, the abrasive article may be pulled through one or more resistance elements 752, in some embodiments, to ensure that only one abrasive article is removed at a time.

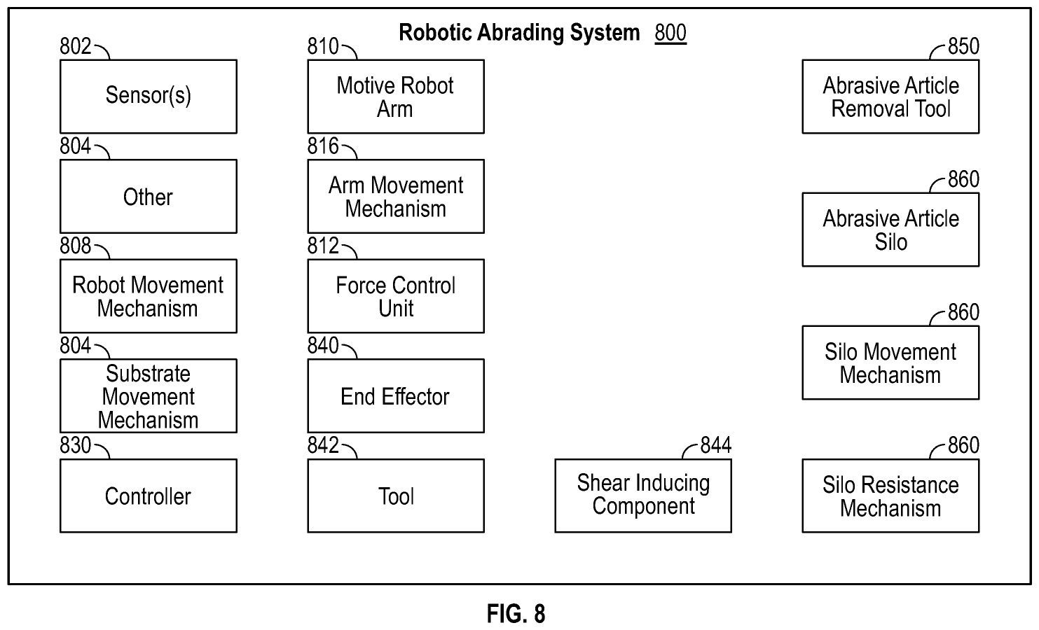

FIG. 8 illustrates a robotic abrading system in accordance with embodiments herein. FIG. 8 illustrates a number of components that may be part of one or more robotic units or otherwise positioned within a range of movement of a robotic abrading unit. For example, one or more sensors 802 may be positioned to detect whether an abrasive article has successfully been picked up, or removed, from a backup pad or other tool.

Robotic abrading system 800 includes a motive robot arm 810 with one or more joints that allow for a range of movement. The robotic arm 810 includes an arm movement mechanism 816, or multiple mechanisms 816 that, in response to a command from a controller 830, move the robotic arm into one or more positions of an abrasive operation.

Motive robot arm 810 may also have a force control unit 812 that modulates an amount of force applied to a tool 842, such as a backup pad to which an abrasive article is attached. Tool 842 may also include a spindle (not shown) which can rotate. An end effector 840 may be present as another movement mechanism to effect movement across a substrate.

Robotic abrading system 800 also includes an abrasive article removal tool 850 that removes a used abrasive article from tool 842. Abrasive article removal tool may be a clamp or other mechanical tool that decouples an abrasive article from 842. However, other suitable abrasive article removal tools 850 are also possible. The abrasive article may be coupled to a tool 842 using a reversible coupling technique, such as adhesive, interlocking components, a hook and loop system, or another suitable mechanism.

New abrasive articles may be stored in an abrasive article silo 860 that is within range of motive robot arm. Abrasive article silo 860 may have one or more resistance mechanisms 860 that help to ensure that only a single abrasive article is removed from storage component 860 at a time. It is expressly contemplated that, in some embodiments, an abrasive article is not circular in shape, e.g. square shaped sander pads for non-rotating abrading operations and, therefore, it is not intended that the term “silo” be constructed as strictly cylindrical. Any suitable shape for housing a consumable article of any given shape is envisioned herein.

A shear inducing component 844 is illustrated in FIG. 8 as a separate component, but it is expressly contemplated that, in some embodiments, shear inducing component is one of tool 842, end effector 840, or a silo movement mechanism 860. However, shear inducing component 844 may be a separate component. In embodiments here, shear inducing component causes a shearing motion between tool 842 and an abrasive article during an abrasive article attachment step. Tool 842 is placed in contact with the abrasive article, and the shearing motion causes a mechanical coupling mechanism to have a better initial coupling. Importantly, shear inducing component 844 does not significantly increase a force or movement needed by abrasive article removal tool 850 to remove the abrasive article when the operation is done. Tool 842 may have a spindle that rotates tool 842 against the abrasive article. End effector 840 may rotate tool 842, move tool 842 in a random orbital movement, move tool 842 linearly, or vibrate tool. Additionally, arm movement mechanism 816 may move tool 842 in a linear, rotary or random orbital movement. However, it is also expressly contemplated that the shearing motion may be caused by a silo movement mechanism 860 that causes the abrasive article to move in a rotary, random orbital, linear or vibratory fashion.

It is expressly contemplated that, while movement in the X-Y direction causes shearing, the movement may not be exclusively in the X-Y direction. For example, a backup pad may “rock” back and forth across the abrasive article to urge more contact and better coupling between the abrasive article and the backup pad. The backup pad, therefore, may move in the Z-direction while also moving in the X-Y direction.

In some embodiments, tool 842 couples to an abrasive article using a hook and loop attachment system, with one of the hooks and loops on tool 842 and the other on the abrasive article. Shear inducing component 844 causes more hooks to couple to more loops initially, causing a better initial attachment.

In some embodiments, motive robotic arm is stationary in an industrial setting. However, it is expressly contemplated that it may also include a movement mechanism 808 that moves the robot arm. Additionally, while in some embodiments a substrate is in a fixed position, it is also expressly contemplated that a substrate may have a movement mechanism 804 that moves a substrate with respect to a robotic unit.

Robotic abrading system 800 also includes a controller 830 that generates movement instructions for other components in system 800, for example, causing an abrasive article to follow a specific trajectory, at a specific speed, with a specific force profile, at a specific angle, etc.

It is expressly contemplated that robotic abrading system 800 may also have other components 804 than those illustrated in FIG. 8.

As discussed herein, a workpiece may be any suitable material, such a metal, wood, or other material. Additionally, as discussed herein, the term abrasive article is used broadly to refer to any abrasive consumables including, but not limited to, sanding discs, polishing discs. polishing pads. wiping articles. buffing articles. or any other suitable article.

What is claimed is:

1. A robotic system for modifying a surface, the system comprising:
a motive robot arm with an arm movement mechanism;
a tool coupled to the arm movement mechanism, wherein the tool is configured to removably couple to an article configured to contact the surface; and
a first actuator that causes the arm movement mechanism to move the tool into a pickup position with respect to the article; and
a second actuator that causes a shearing motion, during an article attachment step, between the article and the tool, wherein the coupling between the article and the tool comprises a hook and loop system.

2. The system of claim 1, wherein the shearing motion is a movement of the motive robot arm or a component of the motive robot arm.

3. The system of claim 1, wherein the shearing motion is a movement of an article storage component.

4. The system of claim 1, wherein the actuator is remote from the motive robot arm.

5. The system of claim 4, wherein the actuator is associated with a storage component of the article.

6. The system of claim 1, wherein moving comprises an arc, a partial rotation, a linear movement.

7. The system of claim 1, wherein moving comprises vibratory movement.

8. The system of claim 1, wherein moving comprises a rocking motion.

9. The system of claim 1, wherein the hooks of the hook and loop system are part of the tool.

10. The system of claim 9, wherein the hooks of the hook and loop system are part of the article.

11. A method of replacing an abrasive article, the method comprising:
removing a first article from a robotic tool;
contacting the robotic tool to a second article, wherein the robotic tool couples to the second article using a hook and loop system; wherein contacting comprises contact between hook components and loop components; and
moving the robotic tool or the article to increase a coupling between the hook components and loop components during an initial coupling of the abrasive article to the robotic tool.

12. The method of claim 9, wherein moving comprises movement in an X-Y plane.

13. The method of claim 10, wherein moving comprises an arc, a partial rotation, a linear movement, a random orbital movement, or any combination thereof.

14. The method of claim 10, wherein moving comprises vibratory movement.

15. The method of claim 10, wherein moving comprises a rocking motion.

16. The method of claim 9, wherein the coupling comprises a hook and loop system.

17. A storage component for an abrasive article, wherein the storage component comprises a material that is deformable or compressible.

18. The storage component of claim 17, wherein the material is a sleeve within the storage component, and wherein the sleeve is housed within a rigid housing.

19. (canceled)
